(19) United States
(12) Patent Application Publication
(10) Pub. No.: US 2014/0086553 A1
(43) Pub. Date: Mar. 27, 2014

(54) APPARATUS, METHOD, AND SYSTEM FOR VIDEO CONTENTS SUMMARIZATION

(71) Applicant: ELECTRONICS AND TELECOMMUNICATIONS RESEARCH, Institute , Daejeon (KR)

(72) Inventors: Jin Young MOON, Daejeon (KR); Young Rae KIM, Daejeon (KR); Hyung Jik LEE, Gwanpyeong (KR); Chang Seok BAE, Daejeon (KR); Sung Won SOHN, Daejeon (KR)

(73) Assignee: Electronics and Telecommunications Research Institute, Daejeon (KR)

(21) Appl. No.: 13/778,918

(22) Filed: Feb. 27, 2013

(30) Foreign Application Priority Data
Sep. 26, 2012 (KR) 10-2012-0107184

(51) Int. Cl. H04N 9/87

(52) U.S. Cl. CPC H04N 9/87
USPC 386/239

(57) ABSTRACT

Disclosed are an apparatus and a method for summarizing a video based on a user, the apparatus including: a gaze information collecting unit to receive gaze information of a user about video data; a memory unit to manage identification information used to identify an object that is a target of the gaze information among objects included in the video data; a control unit to recognize an object of interest to which the user pays attention using the gaze information and the identification information; and a summarizing unit to generate summary data of the video data including the recognized object of interest. According to the present invention, summary data may be generated based on a frame that a user considers important, or an object or a human present within the frame.

### CROSS-REFERENCE TO RELATED APPLICATIONS

This application claims priority to and the benefit of Korean Patent Application No. 10-2012-0107184 filed in the Korean Intellectual Property Office on Sep. 26, 2012, the entire contents of which are incorporated herein by reference.

### TECHNICAL FIELD

The present invention relates to an apparatus and a method for summarizing a video based on a user that recognizes a focused area, object, or human within a frame using gaze information of a user viewing a video, and generates a video abstract based on a focused frame, shot, or scene, or a focused object or human using a biosignal of the user.

### BACKGROUND ART

Existing video summarization technology is technology that classifies a scene including a set of frames using features of images constituting a video, and summarizes the video based on an important frame, shot, or scene using a scene change or additionally using additional information such as a headline of news, subtitles of a movie, and a scoreboard of a sporting event.

However, existing technologies may not summarize a video based on a frame, a shot, or a scene including a predetermined object that a user considers important or is interested in.

### SUMMARY OF THE INVENTION

The present invention has been made in an effort to provide an apparatus and a method for summarizing a video based on a user that verifies a target to which a user viewing or recording a video pays attention through gaze information of the user, recognizes a biosignal of the user, measures an attention level, and thereby generates a video abstract based on the target that the user is interested in based on the measured attention level.

An exemplary embodiment of the present invention provides an apparatus for summarizing a video based on a user, the apparatus including: a gaze information collecting unit to receive gaze information of a user about video data; a memory unit to manage identification information used to identify an object that is a target of the gaze information among objects included in the video data; a control unit to recognize an object of interest to which the user pays attention using the gaze information and the identification information; and a summarizing unit to generate summary data of the video data including the recognized object of interest.

The video summarizing apparatus may further include a biosignal collecting unit to receive a biosignal of the user. The control unit may recognize the object of interest to which the user pays attention using the gaze information, the identification information, and the biosignal.

The summarizing unit may generate reduced video data that includes a frame of the video data including the recognized object of interest.

The summarizing unit may make an annotation of an attention level on a frame of the video data or partial video data including the recognized object of interest, as metadata about the video data.

The summarizing unit may generate the summary data of the video data using the annotation.

The control unit may include: an object recognizing unit to recognize the object using the gaze information and the identification information; and an attention level analyzing unit to analyze an attention level of the user about the object using the received biosignal. The control unit may recognize the object of interest based on the attention level of the object.

The summarizing unit may rank unit data that constitutes a frame of the video data including the object or a video based on the attention level, and may generate the summary data based on a ranking.

The video data may be data displayed for a user through a display unit or data recorded by the user.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating an apparatus for summarizing a video based on a user according to an exemplary embodiment of the present invention.

FIG. 2 is a block diagram illustrating an apparatus for summarizing a video based on a user according to another exemplary embodiment of the present invention.

FIG. 3 is a detailed block diagram illustrating an apparatus for summarizing a video based on a user according to an exemplary embodiment of the present invention.

FIGS. 4 and 5 are diagrams illustrating an application example of an apparatus for summarizing a video based on a user according to an exemplary embodiment of the present invention.

FIG. 6 is a block diagram illustrating a system applied with an apparatus for summarizing a video based on a user according to an exemplary embodiment of the present invention.

FIG. 7 is a flowchart illustrating a method for summarizing a video based on a user according to an exemplary embodiment of the present invention.

FIG. 8 is a flowchart illustrating a method for summarizing a video based on a user according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

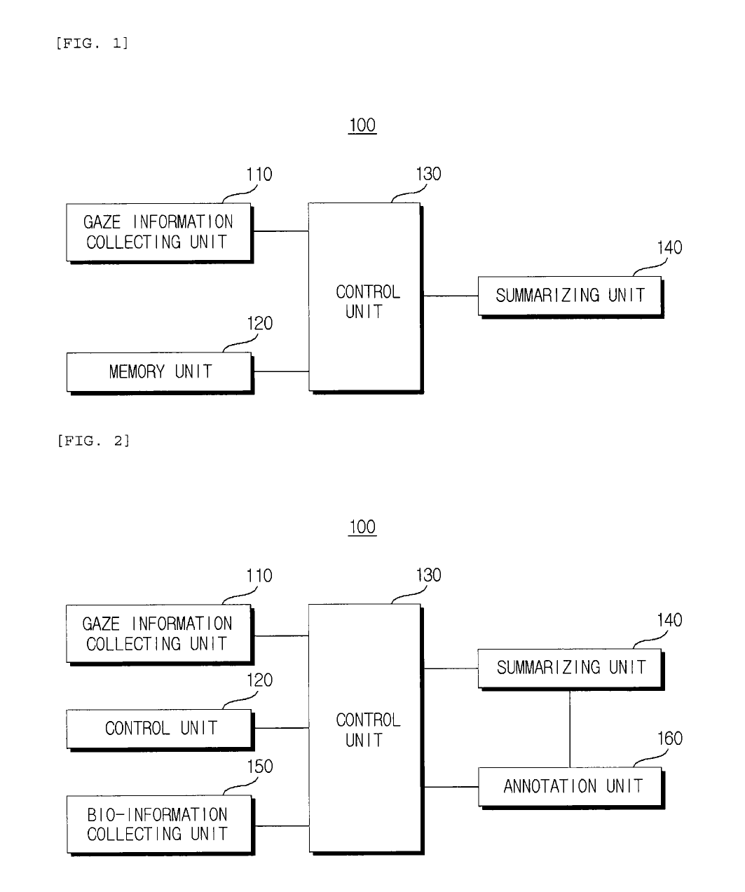

FIG. 1 is a block diagram illustrating an apparatus 100 (hereinafter, video summarizing apparatus 100) for summarizing a video based on a user according to an exemplary embodiment of the present invention. Referring to FIG. 1, the video summarizing apparatus 100 according to the present exemplary embodiment includes a gaze information collecting unit 110, a memory unit 120, a control unit 130, and a summarizing unit 140.

The video summarizing apparatus 100 according to the present exemplary embodiment recognizes an object of interest as an attention target of a user using gaze information of the user about video data that the user pays attention to, without an intentional input of the user indicating that the user pays additional attention, extracts only a portion including the object of interest to which the user pays attention, and thereby generates summarized data.

The term “based on a user” indicates that data is summarized based on a frame, a shot, or a scene that the user considers important or is interested in, which is different from the aforementioned method of using additional information such as subtitles of a movie or a scoreboard of a sporting event. Hereinafter, a configuration of the video summarizing apparatus 100 according to the present exemplary embodiment will be described.

The gaze information collecting unit 110 receives gaze information of a user about video data. The gaze information about video data may be gaze information of the user that is obtained from a predetermined gaze tracking apparatus such as a camera or an eye tracker. The gaze information may be expressed as coordinate information on the video data.

The memory unit 120 manages identification information used to identify an object that is a target of the gaze information among objects included in the video data. In the present exemplary embodiment, the object may be a human or a thing that appears in the video data, and includes all of the targets that are to be gazed by the user.

In the present exemplary embodiment, to recognize a predetermined human in the video data, identification information about a facial pattern of the human may be pre-constructed. For example, according to an exemplary embodiment, in a case in which a viewer focuses on a hero, when the user desires to verify a frame of a video in which the hero appears or a position within the frame, pattern information about a face of the hero needs to be constructed in a database as identification information. Accordingly, in the present exemplary embodiment, the memory unit 120 may be a database system that manages a database about such identification information.

In the present exemplary embodiment, identification information used to identify objects may be generated by the user. Therefore, the user may database identification information fitting propensity of the user in advance and apply the databased identification information to the video summarizing apparatus 100, thereby generating summary data close to a user taste.

The control unit 130 recognizes an object of interest to which the user pays attention using the gaze information and the identification information. That is, in the video data that the user pays attention to, the control unit 130 recognizes a specific target to which the user pays attention within the video data using the gaze information of the user.

That is, using the gaze information of the user obtained through the gaze information collecting unit 110, the control unit 130 recognizes the specific target within video data corresponding to the gaze information. For example, when a target corresponding to gaze information is a character appearing in a video, the control unit 130 may compare facial information of the corresponding character with identification information of the database managed by the memory unit 120 and thereby specifically recognize the specific target.

Referring to FIG. 3, the control unit 130 according to the present exemplary embodiment may include an object recognizing unit 132 to recognize an object using gaze information and identification information.

The gaze information collecting unit 110 collects gaze information of the user by recognizing an image that is photographed from a gaze observing camera for observing a gaze as a gaze detecting apparatus 200 of the user, or an image that is photographed from the gaze detecting apparatus 200 and a portable device 300 including biosignal measuring units 300a, . . . , 300n. The collected gaze information of the user may be defined as coordinate information (x, y) on a display screen. The object recognizing unit 132 of the control unit 130 recognizes an attention target of the user by analyzing the collected gaze information and the video data. In the present exemplary embodiment, the object recognizing unit 132 recognizes an object corresponding to the attention target of the user by analyzing information about a gazing point and the video data. That is, the object recognizing unit 132 recognizes an object in the video data as the attention target based on the collected gaze information. Therefore, when an object corresponding to a gazing point (x, y) used as the gaze information is a predetermined human in the video data, the object recognizing unit 132 may recognize the predetermined human as the object (human5).

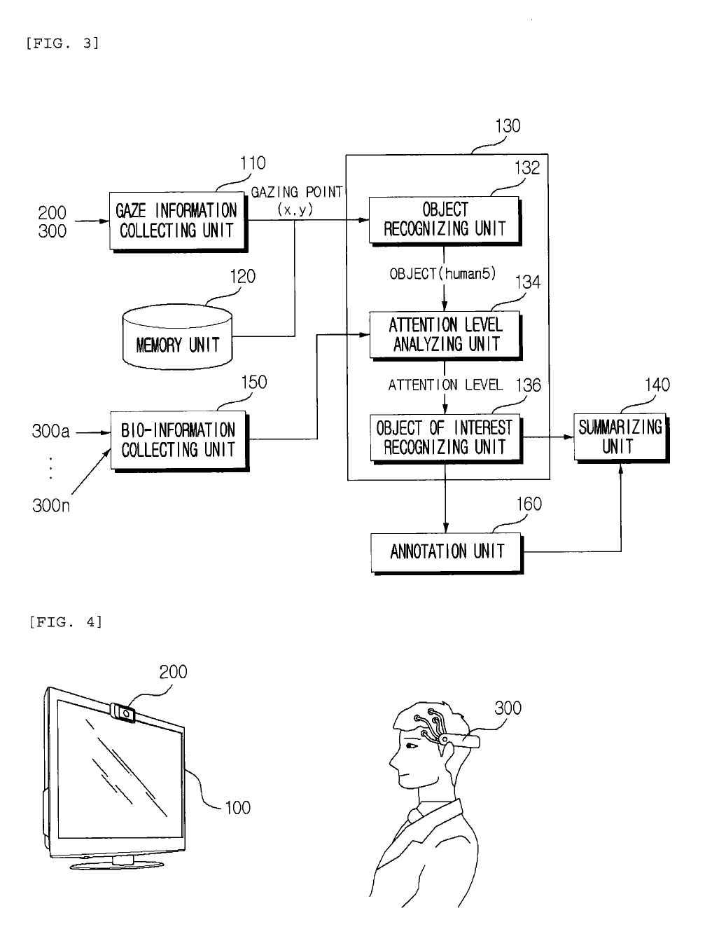

Referring again to FIG. 2, the video summarizing apparatus 100 according to the present exemplary embodiment may further include a bio-information collecting unit 150. The control unit 130 may recognize the object of interest based on bio-information collected from the bio-information collecting unit 150.

That is, in the present exemplary embodiment, the term “attention” relates to gazing a predetermined target and at the same time, paying attention with great interest. Therefore, in the present exemplary, the “attention” may indicate an attention level that is determined by verifying a position of a gaze that the user casts and by employing bio-information when the user fixes the user's eyes.

The bio-information collecting unit 150 receives bio-information of the user. In the present exemplary embodiment, the bio-information is information used to verify an attention level of the user. The bio-information is information including cardiac electricity, cardiac sound, and the like that occur in a living body. Therefore, in the present exemplary embodiment, the bio-information indicates information obtained through a biosignal such as Electroencepharography (EEG), Electrooculography (EOG), skin conductivity, heart rate, and the like. EEG is information about an electrical activity of human brain and indicates a signal with respect to a predetermined chemical action speed and an electrical stimulus of brain. EOG is an electro-oculogram and potential recorded using electrodes attached to the skin around eyes, and indicates information obtained by detecting an eye motion. Accordingly, bio-information received by the bio-information collecting unit 150 according to the present exemplary embodiment may be an attention level and a feeling state of the user that is measured using bio-information measuring apparatuses such as EEG, EOG, skin conductivity, heart rate, and the like.

Referring to FIG. 3, the control unit 130 according to the present exemplary embodiment further includes an attention level analyzing unit 134. The attention level analyzing unit 134 analyzes the attention level of the user about the object using the received bio-information.

The attention level analyzing unit 134 may recognize the attention level by recognizing bio-information that is received by the bio-information collecting unit 150 from the plurality of bio-information measuring apparatuses 300a to 300n measuring bio-information of the user, and by analyzing the recognized bio-information. A case in which the attention level is recognized using a plurality of items of bio-information measured by the plurality of bio-information measuring apparatuses 300a to 300n may decrease an error occurrence probability of the attention level, compared to case in which a single item of bio-information is used. It is also possible to objectively recognize the attention level, deviating from a variety of external effects.

Accordingly, in the present exemplary embodiment, the attention level analyzing unit 134 may analyze the attention level through EEG, or may determine the attention level using a plurality of items of bio-information such as EEG, EOG, skin conductivity, heart rate, and the like. Referring to FIG. 3, the attention level analyzing unit 134 according to the present exemplary embodiment may receive and integrate bio-information that is measured by the plurality of bio-information measuring apparatuses 300a to 300n, and may recognize the attention level using the integrated bio-information, or may recognize an attention level integrated by integrating an attention level that is analyzed through each item of bio-information.

Referring to FIG. 3, the control unit 130 according to the present exemplary embodiment may further include an object of interest recognizing unit 136.

The object of interest recognizing unit 136 recognizes an object of interest based on the attention level that is analyzed by the attention level analyzing unit 134 with respect to the object recognized by the object recognizing unit 132.

The control unit 130 may recognize the object of interest to which the user pays attention using the gaze information, the identification information, and the biosignal. Accordingly, in the present exemplary embodiment, the object of interest indicates an object that is recognized as a target to which the user actually pays attention, instead of being a target that a gaze of the user simply settles on, among objects recognized through the gaze information.

In the present exemplary embodiment, when the attention level of the user with respect to the recognized object is greater than or equal to a predetermined threshold level, the recognized object may be determined as the object of interest. Alternatively, together with the gaze information, when the gaze information is maintained for at least a predetermined period of time and when the attention level is greater than or equal to a predetermined threshold level, the recognized object may be determined as the object of interest.

Hereinafter, the summarizing unit 140 to generate summary data of video data including the recognized object of interest will be described.

The summarizing unit 140 generates summary data that includes a set of partial video data including the object of interest. That is, with respect to the attention target that is recognized as a target of attention by the object recognizing unit 132 based on a viewpoint of the user, the summarizing unit 140 generates an abstract of video data based on a frame, a shot, a scene, or an object to which the user pays attention with great interest during the user's viewing or recording, based on the attention level that is recognized by the attention level analyzing unit 134 using the biosignal measured while the user gazes at the attention target.

Referring to FIGS. 2 and 3, the video summarizing apparatus 100 according to the present exemplary embodiment may further include an annotation unit 160.

The annotation unit 160 makes an annotation of the attention level on a frame of the video data or partial video data including the recognized object of interest, as metadata about the video data.

That is, the annotation may be data about video data indicating partial video data including the object of interest of the user in the video data as the metadata. In the present exemplary embodiment, the video summarizing apparatus 100 generates the annotation about the recognized object of interest, and the summarizing unit 140 generates summary data using the generated annotation. The annotation may be generated based on a unit of a corresponding frame or partial video data, or may include, as information, an object of interest, gaze information thereof, an attention level thereof, and the like.

When a plurality of objects of interest is present, it is possible to generate summary data for each object of interest using an annotation. It is also possible to generate summary data including a frame or partial data having an attention level of at least a predetermined ranking by ranking attention levels.

In the present exemplary embodiment, partial video data may be unit data obtained by temporally or spatially dividing video data. That is, the annotation may be used as temporal or spatial position information on video data that includes an object of interest for summarizing the video data. Therefore, the summarizing unit 140 generates summary data using the annotation. To temporally or spatially divide the video data may be to temporally divide the video data based on a running time of the video data, or may be to divide the video data into frames constituting a video, and to generate, as summary data, a frame that includes the object of interest. Accordingly, temporal division includes dividing the video data based on a time unit such as an hour, a minute, a second, and the like, and also includes dividing the video data based on a unit of a video constituent element using a physical characteristic of a frame, a shot, a scene, and the like constituting the video.

Spatial division is to divide a space within the video data and thus, may be to two-dimensionally divide a screen of the video displayed for the user. The spatial division may be to divide the space within the video data based on a relative position of an object displayed on the video.

For example, in a case in which an event such as tennis or volley ball is performed in a divided area in video data about a sporting event, an object of interest may be an area about a team. In the case of an event such as soccer, the object of interest may be recognized as a predetermined player. Accordingly, when the object of interest is verified as an activity area of a supporting team through an annotation, it is also possible to generate summary data including only the activity area of the team in the entire video data.

Taking educational video data as an example, the educational video data may be generally divided into a human delivering educational information and a presentation screen for transferring the educational information to a user. In the educational video data, a position of the human and a position of the presentation screen are fixed. Therefore, when an object of interest is verified as the presentation screen through an annotation, it is also possible to generate summary data including only the presentation screen in which the human is not included.

Accordingly, in the present exemplary embodiment, the annotation may be data including an attention level of the user about temporally or spatially divided partial video data. It is also possible to generate a plurality of annotations on a plurality of items of partial data that is spatially divided again with respect to a portion of temporally divided partial data.

As summary data generated in the present exemplary embodiment, an abstract of the video may be a combination of annotated temporally or spatially divided partial video data in the entire video data.

That is, in the present exemplary embodiment, the summarizing unit 140 divides the entire video based on a unit of a video constituent element (frame, shot, or scene) using a physical characteristic, receives the generated annotation from the annotation unit 160, and determines a ranking of the divided video constituent element based on an object of interest or an attention level. The summarizing unit 140 selects video constituent element data to be used for summary data based on the determined ranking, and generates a video abstract as summary data using the selected video constituent element data. To determine a ranking of unit data constituting the video data is to generate summary data of a level required by the user. Accordingly, to determine a ranking of unit data may be to determine a level of summary in the present exemplary embodiment. It is also possible to generate a plurality of items of summary data based on a variety of attention levels using the determined ranking.

It is possible to generate summary data about a hero or summary data about a heroine by dividing video data based on an object of interest.

In the present exemplary embodiment, video data to be summarized is generally classified into two. One case is a video that the user views through a display apparatus and the other case is a video that the user records using a portable terminal such as a mobile eye tracker or a portable camera. In above both cases, gaze information about an object at which the user gazes within the video is obtained and an attention target or an attention area is recognized by recognizing a gaze of the user within the video. FIG. 4 is a diagram illustrating a system to which the video summarizing apparatus 100 is applied according to an exemplary embodiment of the present invention is applied.

In the present exemplary embodiment, the video summarizing apparatus 100 may be embedded in a display apparatus, or may be configured as a separate apparatus such as a set-top box. FIG. 4 illustrates a case in which the video summarizing apparatus 100 is embedded in the display apparatus and thus, illustrates a case in which video data desired to be summarized is a video that the user views through the display apparatus 100. FIG. 4 illustrates the display apparatus 100, the gaze detecting apparatus 200, and a biosignal measuring unit 300.

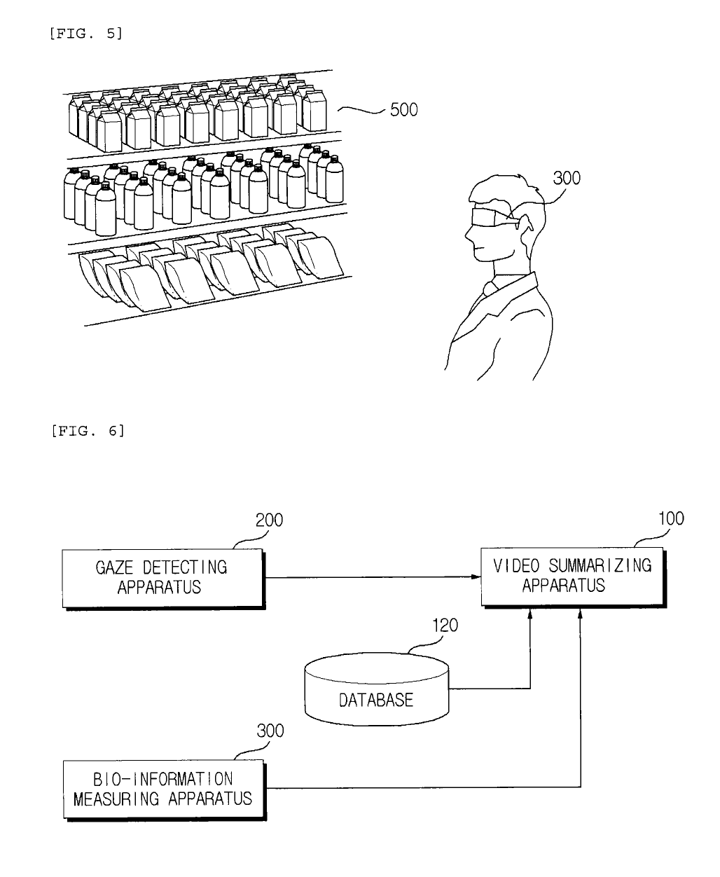

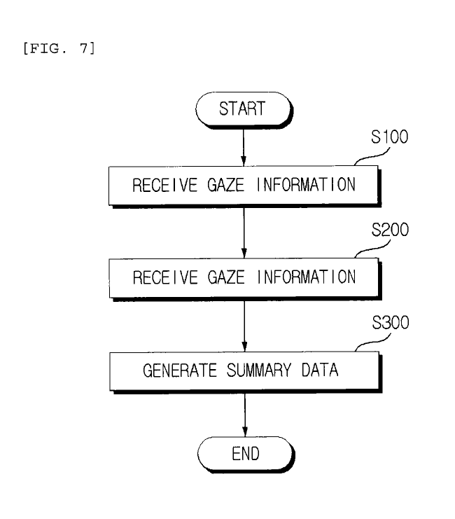

FIG. 5 illustrates a case in which video data desired to be summarized by the video summarizing apparatus 100 according to an exemplary embodiment of the present invention is a video that the user records through the portable device 300 by gazing a product 500 displayed on a selling board. Using information that is input using the gaze detecting apparatus 200 and the portable device 300 including the biosignal measuring unit, the video summarizing apparatus 100 recognizes an attention target and an attention level.

Describing a summarizing process through the video summarizing apparatus 100 of FIGS. 4 and 5 with reference to FIG. 6, FIG. 6 is a block diagram illustrating a video summarizing system applied with the video summarizing apparatus 100 according to an exemplary embodiment of the present invention. The video summarizing system according to the present exemplary embodiment includes the gaze detecting apparatus 200, a bio-information measuring apparatus 300, the video summarizing apparatus 100, and a database 400 to manage a memory unit (not shown) of the video summarizing apparatus 100.

The gaze detecting apparatus 200 (the gaze observing camera 200 for observing a gaze in FIG. 4 and the portable device 300 in FIG. 5) photographs a gaze of the user.

The video summarizing apparatus 100 collects gaze information of the user by recognizing an image photographed from the gaze detecting apparatus 200, and recognizes an object based on identification information of the database 400.

The video summarizing apparatus 100 analyzes an attention level by receiving bio-information measured from the bio-information measuring apparatus 300 with respect to the recognized object, and recognizes an object of interest based on the analyzed attention level. Next, the video summarizing apparatus 100 generates summary data including a set of partial video data including the object of interest.

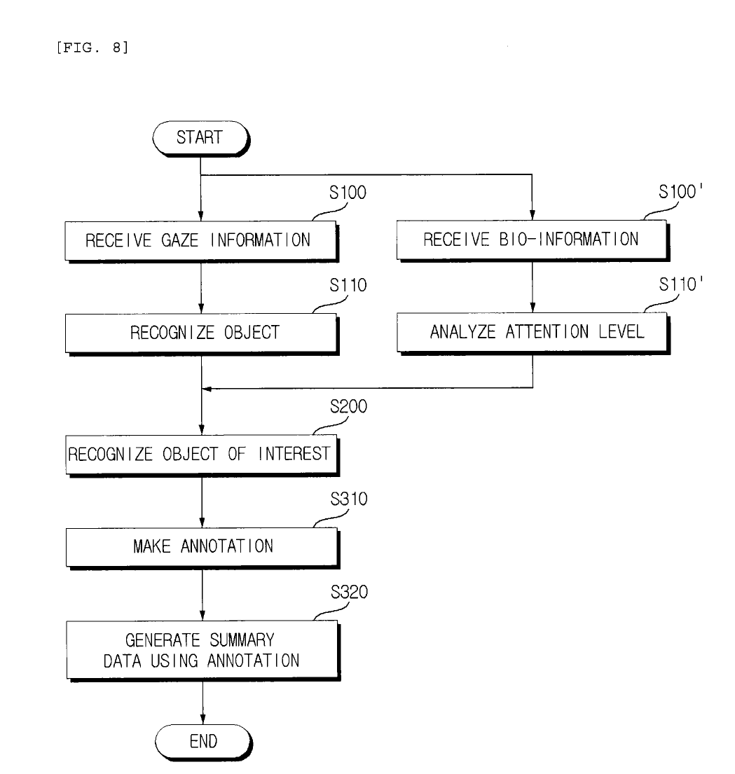

Hereinafter, a video summarizing method performed by the aforementioned user-based video summarizing apparatus will be described with reference to FIGS. 7 and 8.

FIG. 7 is a flowchart illustrating a method for summarizing a video based on a user according to an exemplary embodiment of the present invention.

In the present exemplary embodiment, the video summarizing method includes a gaze information receiving operation S100, an object of interest recognizing operation S200, and a summary data generating operation S300.

In the gaze information receiving operation S100, the gaze information collecting unit 110 receives gaze information of a user about video data.

In the object of interest recognizing operation S200, the control unit 130 recognizes an object of interest to which the user pays attention using the gaze information and identification information used to identify an object that is a target of the gaze information of the memory unit 120 among objects included in the video data.

In the summary data generating operation S300, the summarizing unit 140 generates summary data of the video data including the recognized object of interest.

Hereinafter, further describing the video summarizing method with reference to FIG. 8, the video summarizing method according to the present exemplary embodiment may further include an object recognizing operation S110, an bio-information receiving operation S100′, and an attention level analyzing operation S110′. The summary data generating operation S300 may further include an annotation operation S310 and an annotation used summary data generating operation S320.

In the object recognizing operation S110, the object recognizing unit 132 of the control unit 130 recognizes an object that is an attention target to which the user pays attention by recognizing information about a gazing point and a video.

In the bio-information receiving operation S100′, the bio-information collecting unit 150 receives bio-information of the user. In the attention level analyzing operation S110′, the attention level analyzing unit 134 analyzes an attention level of the user with respect to the object using the received bio-information.

In the annotation operation S310, the annotation unit 160 makes an annotation of the attention level on a frame of the video data or partial video data including the recognized object of interest, as metadata about the video data.

In the annotation used summary data generating operation S320, the summarizing unit 140 generates summary data of the video data using the annotation.

Each operation of the video summarizing method according to the present exemplary embodiment corresponds to the aforementioned video summarizing method performed by the video summarizing apparatus and a detailed description related thereto is repeated and thus, will be omitted hereinafter.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for summarizing a video based on a user, the apparatus comprising:
a gaze information collecting unit to receive gaze information of a user about video data;
a memory unit to manage identification information used to identify an object that is a target of the gaze information among objects included in the video data;
a control unit to recognize an object of interest to which the user pays attention using the gaze information and the identification information; and
a summarizing unit to generate summary data of the video data including the recognized object of interest.

2. The apparatus of claim 1, further comprising:
a biosignal collecting unit to receive a biosignal of the user,
wherein the control unit recognizes the object of interest to which the user pays attention using the gaze information, the identification information, and the biosignal.

3. The apparatus of claim 1, wherein the summarizing unit generates reduced video data that includes a frame of the video data including the recognized object of interest.

4. The apparatus of claim 1, wherein the summarizing unit makes an annotation of an attention level on a frame of the video data or partial video data including the recognized object of interest, as metadata about the video data.

5. The apparatus of claim 4, wherein the summarizing unit generates the summary data of the video data using the annotation.

6. The apparatus of claim 2, wherein the control unit comprises:
an object recognizing unit to recognize the object using the gaze information and the identification information; and
an attention level analyzing unit to analyze an attention level of the user about the object using the received biosignal, and
the control unit recognizes the object of interest based on the attention level of the object.

7. The apparatus of claim 6, wherein the summarizing unit ranks unit data that constitutes a frame of the video data including the object or a video based on the attention level, and generates the summary data based on a ranking.

8. The apparatus of claim 1, wherein the video data is data displayed for a user through a display unit or data recorded by the user.

9. A method for summarizing a video based on a user, the method comprising:
receiving gaze information of a user about video data;
recognizing an object of interest to which the user pays attention using the gaze information and identification information used to identify an object that is a target of the gaze information among objects included in the video data; and
generating summary data of the video data including the recognized object of interest.

10. The method of claim 9, further comprising:
receiving a biosignal of the user,
wherein the recognizing of the object of interest comprises recognizing the object of interest to which the user pays attention using the gaze information, the identification information, and the biosignal.

11. The method of claim 9, wherein the generating of the summary data comprises generating reduced video data that includes a frame of the video data including the recognized object of interest.

12. The method of claim 9, wherein the generating of the summary data comprises making an annotation of an attention level on a frame of the video data or partial video data including the recognized object of interest, as metadata about the video data.

13. The method of claim 12, wherein the generating of the summary data comprises generating the summary data of the video data using the annotation.

14. The method of claim 10, wherein the recognizing of the object of interest comprises:
recognizing the object using the gaze information and the identification information;
analyzing an attention level of the user about the object using the received biosignal; and
recognizing the object of interest based on the attention level of the object.

15. The method of claim 14, wherein the generating of the summary data comprises ranking unit data that constitutes a frame of the video data including the object or a video based on the attention level, and generating the summary data based on a ranking.

16. The method of claim 9, wherein the video data is data displayed for a user through a display unit or data recorded by the user.

17. A system for summarizing a video based on a user, the system comprising:
a gaze detecting apparatus to detect gaze information of a user about video data;
a bio-information measuring apparatus to measure bio-information of the user;
a database to manage identification information used to identify an object that is a target of the gaze information among objects included in the video data; and
a video summarizing apparatus to recognize an object of interest to which the user pays attention using the detected gaze information, the identification information, and the bio-information, and to generate summary data of the video data including the recognized object of interest.

18. The system of claim 17, wherein the video data is data displayed for a user through a display unit or data recorded by the user.
